(19) United States
(12) Patent Application Publication
(10) Pub. No.: US 2007/0003388 A1
(43) Pub. Date: Jan. 4, 2007

(54) Method to make a copy of a key from stored data

(76) Inventor: Shing-Hwa Doong, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/172,690

(22) Filed: Jul. 1, 2005

(51) Int. Cl. B23C 3/35

(52) U.S. Cl. 409/82

(57) ABSTRACT

A method to make a copy of a key from stored data has acts of: inputting identifier data, comparing the input identifier data with stored identifier data, responding to the identifier data, transmitting the key data to a key cutting machine and making a copy of the key. Therefore a person can make a copy of a key without actually having a copy of the key. Even when the key has been lost, a copy of the key can be made because the key data has already been stored in the memory.

### BACKGROUND OF THE INVENTION

1. Field of the Invention

The present invention relates to a method to make a copy of a key, especially a method to make a copy of a key from stored data.

2. Description of the Prior Arts

Keys are used to lock and unlock locks in doors, and each key has a key blank with tooth. To lock and unlock a specific lock, the key blank and the tooth must fit the lock cylinder of the specific lock. When the user wants to copy a key, the user must take the key to a locksmith, and the locksmith selects a proper blank, mounts the key and the blank in a key cutting machine and cuts proper tooth on the blank to copy the key. Therefore, the user cannot obtain a copy of a key without having the key. Furthermore, a person is forced to change the entire lock when the key for the lock is lost. Changing the entire lock is much more expensive than just making a copy of a key.

To overcome the shortcomings, the present invention provides a method to make a copy of a key from stored data to mitigate or obviate the aforementioned problems.

### SUMMARY OF THE INVENTION

The main objective of the present invention is to provide a method to make a copy of a key from stored data. The method to make a copy of a key from stored data comprises acts of: inputting identifier data, comparing the input identifier data with stored identifier data, responding to the identifier data, transmitting stored key data to a key cutting machine and making a copy of the key. Therefore, a person can make a copy of a key without actually having the key. Even when no key is available, a person can still make a copy of a key because the key data has already been stored in the memory.

Other objectives, advantages and novel features of the invention will become more apparent from the following detailed description when taken in conjunction with the accompanying drawings.

### BRIEF DESCRIPTION OF THE DRAWINGS

FIG. 1 is a logic diagram of a method to make a copy of a key from stored data in accordance with the present invention;

FIG. 2 is a logic diagram for a new user to store new key data and make a copy of the key in the method in FIG. 1;

FIG. 3 is a logic diagram for an old user to store new key data and make a copy of the key in the method in FIG. 1; and

FIG. 4 is a logic diagram for an old user to associate stored key data to a new user.

### DETAILED DESCRIPTION OF THE PREFERRED EMBODIMENTS

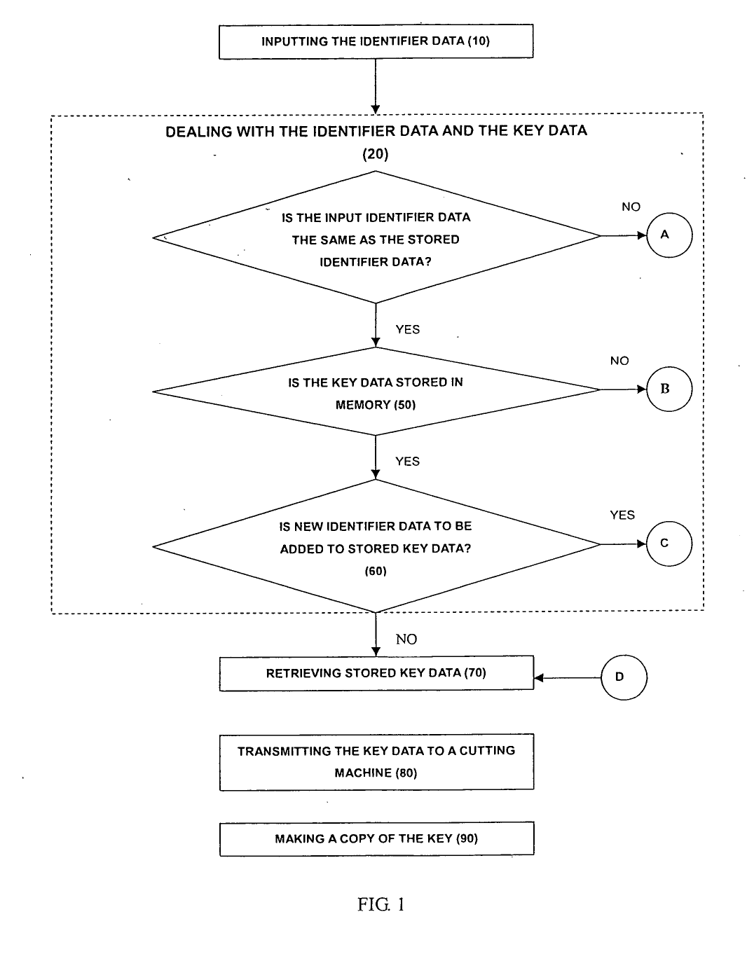

With reference to FIG. 1, a method to make a copy of a key from stored data in accordance with the present invention comprises inputting identifier data (10), dealing with the identifier data and the key data, retrieving the desired stored key data (70), transmitting the key data to a key cutting machine (80) and making a copy of the key (90).

Inputting identifier data (10) may be implemented with optical or magnetic scanners, key pads or the like. Consequently, the identifier data may be a fingerprint, a person's voice, a data sequence recorded on an identification card, a password, a digitized picture or the like.

Dealing with the identifier data and key data comprises acts of determining if the input identifier data is the same as the stored identifier data (20), determining if desired key data is stored in memory (50) and determining if new identifier data is to be added to stored key data (60).

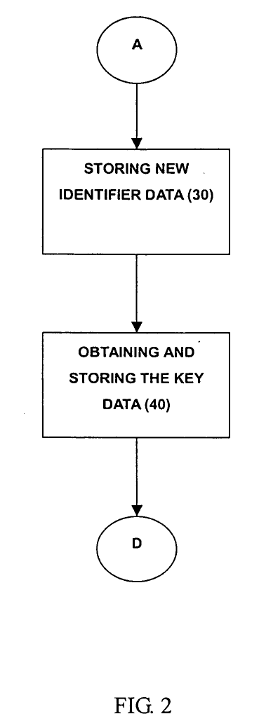

With further reference to FIG. 2, determining if the input identifier data is the same as the stored identifier data (20) comprises acts of comparing the input identifier data with the stored identifier data and may comprise acts of displaying the stored key data, or storing new identifier data (30) and obtaining and storing the key data (40). Comparing the input identifier data with stored identifier data is a security and identification function and comprises act of comparing the input identifier data with all identifier data in memory to determine whether the person inputting the identifier data is in the system and what key data has been stored for that person. When the identifier data has already been stored in the memory, the memory displays the stored key data associated with the identifier data. When the identifier data has not been stored in the memory, storing new identifier data (30) adds a new person to the system and simply stores the input identifier data in memory. When a new person is added to the system, obtaining and storing key data (40) stores new key data in memory. The new key data may be obtained by optical scanning, physical tracing or the like, includes key blank information and the tooth or indentation pattern and is stored with the identifier data.

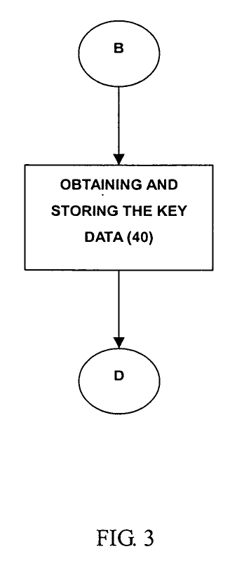

With further reference to FIG. 3, determining if desired key data is stored (50) is performed by users with key data stored in the system and may include simply selecting data for keys stored in memory or inputting key data from a key. A user may store data for additional keys in memory by obtaining and storing key data (40) for new keys. The new key data is obtained and stored in memory in the same way as previously described.

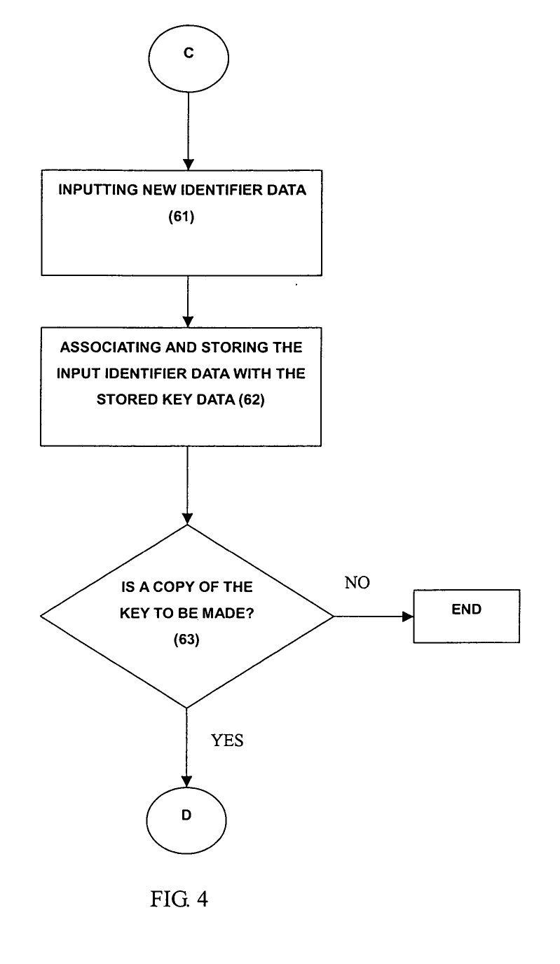

With further reference to FIG. 4, determining if new identifier data is added to stored key data (60) allows multiple people such as family members to be able to make a copy of a specific stored key and may comprise acts of inputting new identifier data (61), associating and storing the input identifier data with the stored key data (62) and deciding whether or not a new key is to be made (63).

Retrieving the desired stored key data (70) comprises acts of retrieving a copy of the desired stored key data and converting the retrieved key data to a format to drive a key cutting machine.

Transmitting the key data to the key cutting machine (80) simply sends the converted key data for the selected key to an appropriate key cutting machine.

Making a copy of the key (90) comprises acts of selecting and mounting an appropriate key blank in an appropriate key cutting machine and cutting the key blank.

The method to make a copy of a key as described has numerous advantages. The identifier data prevents unauthorized users from accessing the stored key data. An authorized user can make a copy of a key without the key. Even when the user loses the key, the user can still make a copy of the key because the key data has already been stored in memory. Therefore a user does not have to change the entire lock when the key is lost and can save a lot of money.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method to make a copy of a key comprising acts of:
inputting an identifier data;
comparing the input identifier data with stored identifier data;
dealing with the identified data and the key data; transmitting the key data to a key cutting machine; and
making a copy of the key.

2. The method as claimed in claim 1, wherein dealing with the identifier data and the key data comprises acts of comparing the input identifier data with the stored identifier data;
displaying the stored key data; and
selecting data for keys stored in memory.

3. The method as claimed in claim 1, wherein dealing with the identifier data and the key data comprises acts of
comparing the input identifier data with the stored identifier data;
storing new identifier data; and
obtaining and storing the key data.

4. The method as claimed in claim 1, wherein the dealing with the identifier data and the key data comprises acts of
comparing the input identifier data with the stored identifier data;
displaying the stored key data; and
inputting key data from a key.

5. The method as claimed in claim 2, wherein dealing with the identifier data and the key data further comprises acts of
inputting new identifier data; and
associating and storing the input identifier data with the stored key data.

6. The method as claimed in claim 1, wherein retrieving the desired stored key data comprises acts of
retrieving a copy of the desired stored key data; and
converting the retrieved key data to a format to drive a key cutting machine.

7. The method as claimed in claim 1, wherein the identifier data is a fingerprint.

8. The method as claimed in claim 1, wherein the identifier data is a person's voice.

9. The method as claimed in claim 1, wherein the identifier data is a data sequence recorded on an identification card.

10. The method as claimed in claim 1, wherein the identifier data is a password.

11. The method as claimed in claim 1, wherein the key data comprises
key blank information; and
tooth.

12. The method as claimed in claim 1, wherein the key data comprises
key blank information; and
indentation pattern.
